(19) United States
(12) Patent Application Publication
(10) Pub. No.: US 2010/0033950 A1
(43) Pub. Date: Feb. 11, 2010

(54) SWITCHPLATE WITH NIGHTLIGHT

(76) Inventor: Becky Farrell, McCalla, AL (US)

Correspondence Address: ITALIA IP, 3500 WEST OLIVE AVE., SUITE 300, BURBANK, CA, 91505, US

(21) Appl. No.: 12/186,827

(22) Filed: Aug. 6, 2008

(51) Int. Cl. F21V 33/00

(52) U.S. Cl. 362/95

(57) ABSTRACT

A switchplate incorporating a nightlight. A nightlight control operator such as a pushbutton is located on the switchplate. The nightlight may be powered from battery cells carried on the switchplate or alternatively by connection to the electrical circuit controlled by the associated switch. In either case, the nightlight may be illuminated by the nightlight control operator at the discretion of the user. The switchplate may have indicia such as text, logos, symbols, and depictions of objects.

### FIELD OF THE INVENTION

The present invention relates to a switchplate for an electrical workbox, wherein the switchplate incorporates a manually operated nightlight.

### BACKGROUND OF THE INVENTION

Wall mounted electrical switches are conventionally employed to control electrical devices, particularly lights in buildings. If it is desired to switch a light on, and the room or other building area where the switch is located is already dark, then a person who is unfamiliar with that room or building area may not be able to locate the light switch readily.

Incorporating nightlights into light switches and other components of buildings has been done to overcome this problem. However, this solution has, where it has been practiced, brought about a new problem that the nightlight is always on when the light controlled by the switch is off, even during the day or when other lights may provide sufficient illumination such that no nightlight is necessary.

There exists a need for a way of illuminating a light switch such that there is no wasteful and unnecessary illumination when a nightlight is not needed.

### SUMMARY OF THE INVENTION

The present invention provides a nightlight for light switches mounted on walls and other surfaces of structures such as buildings, which gives control over operation to a human operator of the switch.

The novel nightlight is incorporated into a switchplate for covering the workbox in which the switch body of the light switch is mounted, and in which electrical connections are made. The nightlight may be powered by battery cells carried on the switchplate, or alternatively by connection to an electrical circuit a conductor of which is contained within the workbox.

The switchplate incorporating the nightlight has a manual switch operated by an externally accessible operator such as a pushbutton, for controlling the nightlight. The nightlight may be illuminated at the discretion of a person rather than operating automatically at unnecessary times, such as during the day.

The switchplate incorporating the nightlight may bear indicia for ancillary purposes, such as personalizing the switchplate and nightlight. This may be for purposes of amusement and education of children, among others. To this end, the indicia may comprise text, such as text which spells out someone's name, or may have a logo, symbol, or depiction of a recognizable object.

It is therefore an object of the invention to provide a switchplate with a nightlight.

Another object of the invention is to provide a nightlight which may be operated only at the discretion of a person.

Another object of the invention is to provide a switchplate and nightlight with adornment for an ancillary purpose such as amusement.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an environmental front view of a combined switchplate and nightlight according to at least one aspect of the invention.

FIG. 2 is a side cross sectional view of the combined switchplate and nightlight of FIG. 1.

FIG. 3 is a circuit diagram of circuitry of a combined switchplate and nightlight according to an aspect of the invention.

FIG. 4 is a side diagrammatic view of a combined switchplate and nightlight which derives power from a circuit passing through the workbox which is covered by the combined switchplate and nightlight.

FIG. 5 is a depiction of exemplary text which may be used to adorn a combined switchplate and nightlight according at least one aspect of the invention.

FIG. 6 shows exemplary indicia depicting a recognizable object which may be disposed on a combined switchplate and nightlight according to at least one aspect of the invention.

FIG. 7 shows exemplary indicia depicting a fictitious character which may be disposed on a combined switchplate and nightlight according to at least one aspect of the invention.

FIG. 8 shows exemplary indicia depicting a symbol which may be disposed on a combined switchplate and nightlight according to at least one aspect of the invention.

### DETAILED DESCRIPTION

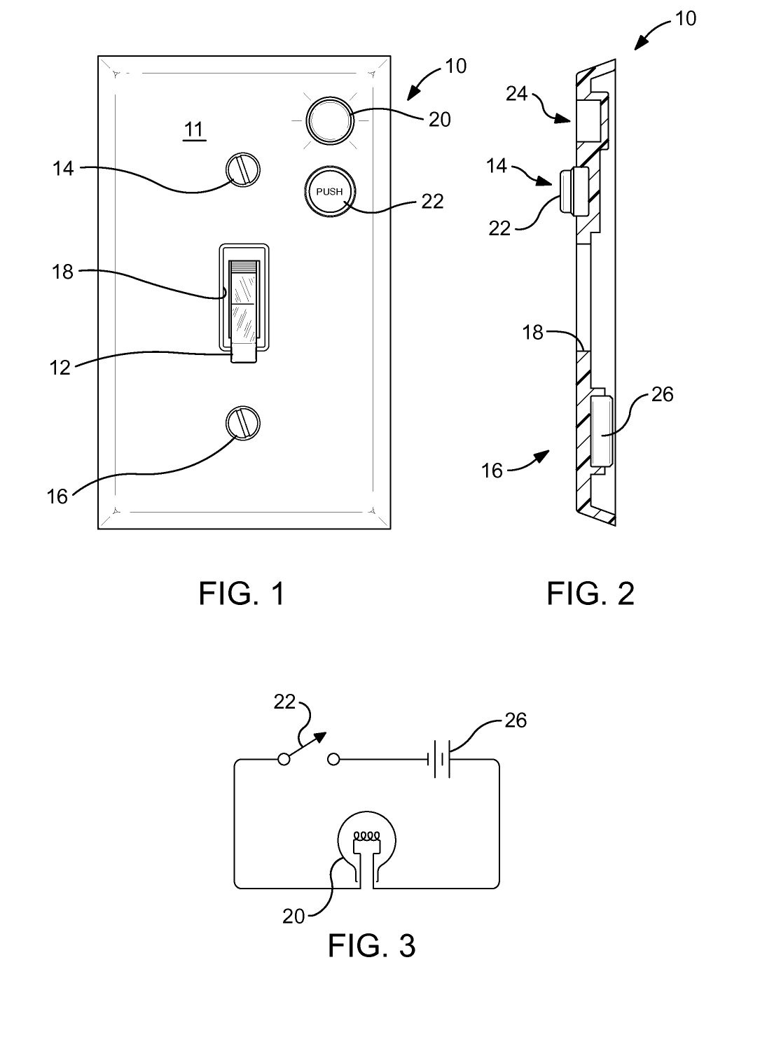

FIG. 1 of the drawings shows a combined switchplate and nightlight 10 for covering and selectively illuminating the vicinity of an electrical workbox (not shown) in which is mounted a manual switch (seen as a toggle lever 12). The workbox and the manual switch are of commonly available commercial products widely used in building construction. Such manual switches are widely utilized to control electrical lighting, but may also be used to switch other loads. The workbox and manual switch typically have standardized dimensions and features, such as the screw hole pattern of the screw holes 14 and 16. The screw holes 14 and 16 are representative of one or more openings which may be provided to accommodate fasteners for fastening the switchplate 11 to the manual switch or directly to the workbox, where the latter arrangement is accommodated.

The combination of two screw holes 14 and 16 and the rectangular opening 18, all aligned along the vertical centerline of the switchplate 11 as shown, render the combined switchplate and nightlight 10 usable with a conventional toggle type manual light (or general purpose) switch and a conventional electrical workbox intended to receive a conventional toggle type manual light switch.

It should be noted at this point that orientational terms such as vertical refer to the referenced object as depicted in the drawings, and as it would appear ordinarily when actually installed for use in conventional fashion.

Openings may vary from the number, dimensions, and configurations of the screw holes 14 and 16. The switchplate 11 may have a rectangular opening 18 for passing an operator of the switch, such as the toggle lever 12, so that the latter may be used when the workbox is covered by the switchplate 11. As with the screw holes 14 and 16, the opening 18 may be varied in dimensions, configuration, and location if desired to accommodate a switch operator (not shown) which is different from the toggle lever 12.

A nightlight 20 is mounted to the switchplate 11 in a location enabling light emitted by the nightlight 20 to be visible to view from the front of the switchplate 11. In the depiction of FIG. 1, the nightlight 20 is mounted on the front surface of the switchplate 11. The front surface is that which faces an observer and is exposed to view when the switchplate 11 is fixed in place covering the workbox bearing the switch which is closed by the switchplate 11.

The nightlight 20 will be understood to include a lamp or other light emitting element (not separately shown), hereinafter referred to as a lamp for brevity, an independent nightlight switch, and a power source. The lamp may be of any known type, such as for example an incandescent lamp, a neon lamp, a light emitting diode. These are commercially available in low power and voltage ratings, as would be appropriate for a light source intended primarily to identify the location of the associated switch in what would otherwise be substantial darkness.

The combined switchplate and nightlight 10 includes a nightlight switch, represented by a pushbutton operator 22, which is supported on the front of the switchplate 11 of the combined switchplate and nightlight 10, the nightlight switch being disposed to control electrical power to be supplied to the lamp.

FIG. 2 shows the combined switchplate and nightlight 10 in side view. A socket 24 is formed in the switchplate 11 to receive the lamp, and to hold the lamp in electrical contact with electrical power. The socket 24 may be configured to receive an Edison base lamp, a bayonet base lamp, or other base of the lamp.

In one aspect of the invention, the combined switchplate and nightlight 10 may have a battery cell or cells 26 coupled to the switchplate 11. Retention of the battery cell or cells 26 may be permanent, or may enable manual removal for replacement, for example. The battery cell or cells 26 provide a power source which may be coupled to the switchplate 11 in a location concealed from view from the front of the switchplate 11.

Referring now to FIG. 3, the power source is disposed to provide power to the nightlight 20, for example, by being connected to the lamp by a suitable circuit, shown diagrammatically. The circuit will be understood to include all necessary components, such as conductors, insulators, clips, connectors, and fasteners, for example, to assure operability of the circuit as described. The switch represented by the pushbutton operator 22 is seen to be disposed to control electrical power to be supplied to the nightlight 20 from the power source, thereby illuminating and extinguishing the nightlight 20 by simple manual actuation of the pushbutton operator 22, using toggle logic. Toggle logic signifies that each successive pressing or actuation of the pushbutton operator opens the circuit if the circuit had been closed immediately prior to actuation, and closes the circuit if the circuit had been open immediately prior to actuation.

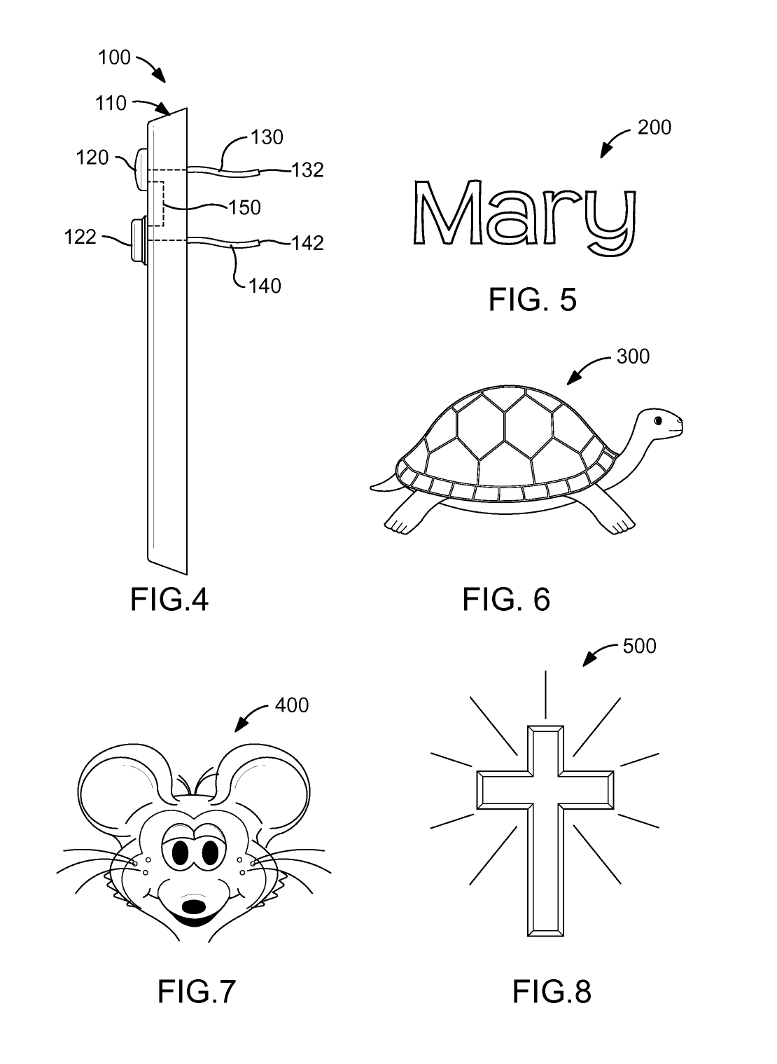

FIG. 4 of the drawings shows a combined switchplate and nightlight 100 according to a further aspect of the invention. The combined switchplate and nightlight 100 may have a switchplate 110, a nightlight (represented by a lamp 120) and a switch (represented by a pushbutton operator 122). The combined switchplate and nightlight 100 may comprise a power source which comprises a connection to the circuit controlled by the manual switch which is covered by the switchplate 110. The power source connection may comprise conductors 130 and 140, which may be connected to one live phase conductor and to a neutral or grounded conductor (neither shown) in a 120 volt system, or to two live phase conductors (not shown) as is typical of a 240 volt system. Of course, circuits connected to the manual switch may operate at other voltages. The conductors 130 and 140 may be connected respectively to the nightlight 120 and to the switch represented as the pushbutton operator 122. At their respective free ends 132 and 142, the conductors 130 and 140 may be screwed to screw terminals formed in the manual switch which is covered by the switchplate 110, for example. The circuit may be completed by a conductor 150 which connects the nightlight 120 and the switch represented as the pushbutton operator 122. All conductors shown in FIG. 4, such as the conductors 130, 140, and 150, will be understood to include insulation jackets (not separately shown) necessary to prevent injuries and damage due to direct contact between the conductors 130, 140, 150 and external objects. The circuit which includes the conductors 130, 140, 150 may operate according to the same logic as that of FIG. 3.

In a further aspect of the invention, a combined switchplate and nightlight, such as the combined switchplate and nightlight 10 or 100 may comprise indicia which may be disposed on the switchplate 11 or 110 and which may be visible from the front of the switchplate 11. The indicia may take many forms and may serve any of many functions.

For example, and referring now to FIG. 5, indicia 200 may comprise characters or letters which spell out a name, plural names, a word, or plural words, or combinations of these. The letters may be initials, such as initials of a person's name, or may be initials of an organization. Illustratively, the initials may be those of a government agency, such as FBI and CIA, may be those of a private service organization, such as KC (representing for example the Knights of Columbus), may be those of a trade union, such as AFL or CIO, may be those of a religious organization or belief, such as UCC (e.g., United Church of Christ), may be those of a college or university, such as USC (e.g., University of Southern California). Any other organization or entity may be represented by initials, by part of the name, or by a combination of these. The letters may be of any alphabet. The characters may be symbols, such as mathematic, scientific, iconographic, and other symbols, by themselves or in combination with letters, numbers and still other characters.

As seen in FIG. 6, the indicia may depict a recognizable object, such as a turtle 300. The recognizable object may be other than a turtle, may be part of an animal or human body, may be a plant or part of a plant, may be a man made object such as a transportation vehicle, toy, weapon, tool, electronic device, sports or amusement device, building, bridge, tower, fort, statue, musical instrument or device, article of scientific or technical nature, such as a microscope, telescope, symbol of authority or power, such as a crown or scepter, or any combination of these.

Referring to FIG. 7, the indicia may comprise a fictitious character, rendered in whole or in part, the part being a recognizable portion of the fictitious character. Illustratively, the fictitious character may be a mouse 400, seen only as the head of the mouse 400. A fictitious character may be one the appearance of which has been widely disseminated, for example on television or over the internet, or one the identity of which is known, but whereof the appearance is not known or may be known in only limited segments of society, or whereof more than one appearance has been disseminated. For example, the mythical god ancient Greece, known as Zeus, is known, but no definite appearance is now authoritatively associated with this character. In a further example, a mascot may be a species of animal, but not of any particular appearance. A mascot may be rendered in a stylized, exaggerated, or humanized form to one degree or another, rather than always rendered realistically. A mascot may therefore take on many different appearances, while always remaining identifiable by virtue of identification by the species. This is particularly true for animal mascots for colleges and universities, for example.

FIG. 8 shows indicia which comprises a symbol. In the example of FIG. 8, the symbol is that of the cross 500. Other symbols which have unique meanings and associations may be used. The symbols may for example be corporate and other organizational logos. Additional indicia may include symbols of tourist locations and landmarks.

Indicia will be understood to be any combination of any of the specific examples of characters, depictions of objects, symbols, and the like described herein. Truncations of objects, symbols, characters, and other pictorial devices are similarly encompassed within the definition of indicia.

It will be understood that the term indicia is broad to the point that examples thereof transcend or span the classifications (e.g. letters, numbers, symbols, depiction of objects, people, fictitious characters, and the like), so that these classifications help define but do not limit the examples of indicia which are contemplated by the invention.

It should be understood that components presented in the singular may be provided in the plural. Where feasible, it would be possible to provide a single component rather than a plurality of components.

Locations described for components of the inventive combined switchplate and nightlight, such as the combined switchplate and nightlight 10 and 100, are exemplary only, and may be modified to suit various appearances, connection schemes, and other arrangements. Components described as stand-alone (i.e., separate) may be provided as integrated with other components. The opposite also is contemplated.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A combined switchplate and nightlight for covering and selectively illuminating the vicinity of an electrical workbox in which is mounted a manual switch, comprising:
a switchplate having a first opening for passing an operator of the manual switch, and at least one second opening for passing a fastener for fastening the switchplate to the workbox;
a nightlight lamp supported on the switchplate in a location enabling light emitted by the lamp to be visible to view from the front of the switchplate;
a power source coupled to the switchplate in a location concealed from view from the front of the switchplate, wherein the power source is disposed to provide power to the nightlight lamp; and
a nightlight switch supported on the switchplate, disposed to control electrical power to be supplied to the nightlight lamp from the power source.

2. The combined switchplate and nightlight of claim 1, wherein the power source comprises a battery cell.

3. The combined switchplate and nightlight of claim 1, wherein the power source comprises a connection to the circuit controlled by the manual switch.

4. The combined switchplate and nightlight of claim 1, wherein the nightlight switch comprises a manually operated pushbutton located on the front of the switchplate.

5. The combined switchplate and nightlight of claim 1, further comprising indicia visible from the front of the switchplate.

6. The combined switchplate and nightlight of claim 5, wherein the indicia comprises text spelling out at least one name.

7. The combined switchplate and nightlight of claim 5, wherein the indicia depicts a recognizable object.

8. The combined switchplate and nightlight of claim 5, wherein the indicia comprises a recognizable portion of a fictitious character.

9. The combined switchplate and nightlight of claim 5, wherein the indicia comprises a symbol.

10. The combined switchplate and nightlight of claim 5, wherein the indicia comprises a tourist location.

11. The combined switchplate and nightlight of claim 5, wherein the indicia comprises a landmark.

12. The combined switchplate and nightlight of claim 1, wherein the first opening for passing an operator of the manual switch is rectangular in configuration, for passing a toggle operator, and the at least one second opening for passing a fastener for fastening the switchplate to the workbox comprises two openings, whereby the combined switchplate and nightlight is usable with a conventional toggle type manual light switch and a conventional electrical workbox intended to receive a conventional toggle type manual light switch.
